(19) United States
(12) Patent Application Publication
(10) Pub. No.: US 2004/0028873 A1
(43) Pub. Date: Feb. 12, 2004

(54) Flocked fabric

(76) Inventors: Bruce E. Corbett, Spartanburg, SC (US); Steve W. Josey, Moore, SC (US); Thomas J. Hinchman, Anderson, SC (US); Roy P. DeMott, Spartanburg, SC (US)

Correspondence Address: Jeffery E. Bacon, Legal Department, M-495, Milliken & Company, P.O. Box 1926, Spartanburg, SC, 29304, US

(21) Appl. No.: 10/213,656

(22) Filed: Aug. 6, 2002

(51) Int. Cl. B32B 33/00; B32B 3/02

(52) U.S. Cl. 428/90; 428/95

(57) ABSTRACT

A flocked fabric having a woven fabric substrate of a blend of polyester and pima cotton. The fabric substrate is covered with an adhesive, and flock is attached to the fabric substrate by the adhesive. A surfactant is applied to the fabric substrate prior to the adhesive.

### BACKGROUND

The present invention relates to flocked fabrics and the components forming such fabrics.

Flocked fabrics generally comprise a cloth, which has been coated by an adhesive and fine fibers applied over the adhesive. The resultant cloth has a velvet like appearance. These fabrics can be used in many applications, such as for upholstery in home furnishings. Typically, the flocking substrate fabric is an osnaburg fabric. An osnaburg fabric is a plain weave that is medium to heavy in weight, and is a coarse fabric often formed partially of waste fiber. However, recent improvements in flocking have allowed imperfections in the flocking substrate fabric to show through the flocked fabric as imperfections in the overall product. Therefore, there is a need for improved flocking substrate fabrics, and improved flocked fabrics using such substrates.

### DETAILED DESCRIPTION

The present invention generally relates to flocked fabrics formed from a flocking substrate fabric, which has been coated with an adhesive and subsequently coated with flock. The flocked fabric of the present invention can be used for many applications, such as upholstery for home furnishings.

The flocking substrate fabric can be a woven fabric (such as plain, twill, satin, dobby, jacquard, leno, or the like) or a knit fabric (such as weft knit or warp knit). In one embodiment, the flocking substrate fabric is formed of spun yarns containing synthetic and natural fibers. It is believed that the natural fibers provide a better surface for the bonding of the adhesive.

In one embodiment of the present invention, the synthetic fibers are a polyester staple and the natural fibers are a pima cotton. Pima cotton is a higher cost material that is not associated in the industry with the lower quality and cost of the materials used in present flocking substrate fabrics. In one embodiment, the blend of materials forming the flocking substrate fabric is about 65% polyester with about 35% cotton, by weight. In another embodiment, the blend of materials is about 85% polyester with about 15% cotton, by weight. It is anticipated that the blend of materials, by weight, can range from about 90% polyester with about 10% cotton, to about 50% polyester with about 50% cotton. The yarns are typically an open-end spun yarn with a cotton count of between about 12 and about 25, with about a 15 cotton count being one potentially preferred embodiment. Where yarns of about a 12 cotton count are used in a plain weave, the weave pattern can range from about 28 ends/inch by about 25 pics/inch to about 40 ends/inch by about 32 pics/inch. Where yarns of about a 25 cotton count are used in a plain weave, the weave pattern can range from about 35 ends/inch by 32 pics/inch to about 45 ends/inch by about 42 pics/inch. Where yarns of about a 15 cotton count are used in a plain weave, the weave pattern can range from about 28 ends/inch by about 28 pics/per inch to about 38 ends/inch by about 44 pics/inch, and preferably are about 32 ends/inch by about 28 pics/inch. The weight of the flocking substrate fabric can range from about 2 oz/yd² to about 4.5 oz/yd², and in one embodiment is preferably from about 3.0 oz/yd² to about 3.8 oz/yd².

In another embodiment of the present invention, the flocking substrate fabric is coated with a surfactant prior to application of the adhesive. It is believed that the surfactant facilitates application of the adhesive onto the flocking substrate fabric to provide a better bond of the flock to the flocking substrate fabric. In particular, application of the surfactant to the flocking substrate fabric improves the application of the adhesive to flocking substrate fabrics which includes synthetic materials, such as a polymeric material. The use of a surfactant can allow the flocking substrate fabric to be 100% synthetic, such as 100% polyester. Although the surfactant can be used with spun yarns in the flocking substrate fabric, the use of a surfactant also facilitates the use of filament yarns in place of the spun yarns. For example, the flocking substrate fabric can have filament polyester yarns in the warp direction, the fill direction, or both, of a woven fabric. The inventors have discovered that a fabric substrate using filament yarn provides a cleaner better quality fabric substrate for flocking, resulting in a better quality flocked fabric.

In yet another embodiment, an exthoxylated polyester is used as a surfactant-type material and is applied to a flocking fabric substrate including polyester filament and/or fiber. The ethoxylated polyester provides the surfactant-type effect of facilitating the adhesive to bond the flock to the flocking substrate, and has a more permanent bond with the polyester of the flocking substrate fabric than many other surfactants. Although ethoxylated polyester can be used with spun yarns in the flocking substrate fabric, ethoxylated polyester also facilitates the use of filament yarns in place of the spun yarns. For example, the flocking substrate fabric with ethoxylated polyester can have filament polyester yarns in the warp direction, the fill direction, or both, of a woven fabric. Possible filament yarns for use with the ethoxylated polyester include polyester yarn of 2 plys of 150 components.

The adhesive is applied to the flocking substrate fabric prior to applying the flock. In one embodiment, the adhesive is a latex adhesive applied to the flocking substrate fabric.

The flock is fibers having a denier range from about 0.8 to about 3.0 denier, with an average denier of about 1.1. The flocking fibers can have a length from about 0.025 inches to about 0.07 inches. The flock is applied to the flocking substrate fabric after application of the adhesive. The flock can be applied by mechanical or electrostatic means. The flock will then adhere to the portion of the flocking substrate fabric which has been coated with the adhesive.

What Is Claimed Is:

1. A flocked fabric including:
a woven fabric substrate comprising from about 50% to about 90% by weight of polyester and from about 10% to about 90% by weight of pima cotton, including substrate yarns having a size of from about 12 cotton count to about 25 cotton count, having an end count of from about 28 ends/inch to about 38 ends/inch and a pic count of from about 32 pics/inch to about 44 pics/inch, and having a weight of from about 2 oz/yd² to about 4.5 oz/yd²;
an adhesive disposed on the fabric substrate
flock adhered to the fabric substrate by the adhesive.

2. The flocked fabric according to claim 1, wherein the fabric substrate comprises about 65% by weight of polyester and about 35% by weight of pima cotton.

3. The flocked fabric according to claim 1, wherein the fabric substrate comprises about 85% by weight of polyester and about 15% by weight of pima cotton.

4. The flocked fabric according to claim 1, wherein the substrate yarns further have a size of about 15 cotton count.

5. The flocked fabric according to claim 1, wherein the fabric substrate further includes an end count of about 32 ends/inch.

6. The flocked fabric according to claim 1, wherein the fabric substrate further includes a pic count of about 28 pics/inch.

7. The flocked fabric according to claim 1, wherein the fabric substrate further comprises a weight of from about 3 oz/yd² to about 3.8 oz/yd².

8. The flocked fabric according to claim 1, wherein the substrate yarns are further open-end spun yarns.

9. A flocked fabric including:
a fabric substrate comprising synthetic polymeric yarns and having a weight of from about 2 oz/yd² to about 4.5 oz/yd²;
a surfactant disposed on the fabric substrate;
an adhesive disposed on the fabric substrate over the surfactant;
flock adhered to the fabric substrate by the adhesive.

10. The flocked fabric according to claim 9, wherein the fabric substrate further comprises a woven fabric having an end count of from about 28 ends/inch to about 38 ends/inch, a pic count of from about 32 pics/inch to about 44 pics/inch.

11. The flocked fabric according to claim 9, wherein the fabric substrate further comprises filament yarns.

12. The flocked fabric according to claim 11, further comprising the fabric substrate being a woven fabric and the filament yarns being disposed in the warp direction.

13. The flocked fabric according to claim 11, further comprising the fabric substrate being a woven fabric and the filament yarns being disposed in the fill direction.

14. A flocked fabric including:
a fabric substrate comprising substrate yarns including polyester, the fabric substrate having a weight of from about 2 oz/yd² to about 4.5 oz/yd²;
ethoxylated polyester disposed on the fabric substrate;
an adhesive disposed on the fabric substrate over the ethoxylated polyester;
flock adhered to the fabric substrate by the adhesive.

15. The flocked fabric according to claim 14, wherein the fabric substrate further comprises a woven fabric having an end count of from about 28 ends/inch to about 38 ends/inch, and a pic count of from about 32 pics/inch to about 44 pics/inch.

16. The flocked fabric according to claim 14, wherein the fabric substrate further comprises filament yarns.

17. The flocked fabric according to claim 16, further comprising the fabric substrate being a woven fabric and the filament yarns being disposed in the warp direction.

18. The flocked fabric according to claim 17, wherein the filament yarns comprise 2 plys of 150 denier components.

19. The flocked fabric according to claim 16, further comprising the fabric substrate being a woven fabric and the filament yarns disposed in the fill direction.

20. The flocked fabric according to claim 19, wherein the filament yarns comprise 2 plys of 150 denier components.
